(19) United States
(12) Patent Application Publication
(10) Pub. No.: US 2020/0266680 A1
(43) Pub. Date: Aug. 20, 2020

(54) MOTOR UNIT

(71) Applicant: NIDEC CORPORATION, Kyoto (JP)

(72) Inventors: Shohei FUJIMOTO, Kyoto (JP); Kazunori TATEGATA, Kyoto (JP); Keisuke FUKUNAGA, Kyoto (JP)

(21) Appl. No.: 16/773,984

(22) Filed: Jan. 28, 2020

(30) Foreign Application Priority Data
Feb. 15, 2019 (JP) 2019-025798

(51) Int. Cl. H02K 5/22; F16H 57/027; F16H 57/04; H02K 7/116; H02K 9/19; H02K 15/14; H02M 7/48

(52) U.S. Cl. CPC H02K 5/22; F16H 57/027; F16H 57/04; H02M 7/48; H02K 9/19; H02K 15/14; H02K 7/116

(57) ABSTRACT

A motor unit includes a motor including a rotor arranged to rotate about a motor axis, and a stator arranged opposite to the rotor; a housing arranged to house the motor; an inverter electrically connected to the motor; a busbar arranged to connect the motor and the inverter to each other; and a cover portion. The housing includes a motor housing portion arranged to house the motor, a top wall portion arranged to cover an upper side of the motor housing portion, and a work-use hole portion arranged to pass through the top wall portion. The cover portion is arranged to close an upper opening of the work-use hole portion. The cover portion includes a pressure regulating passage arranged to regulate the pressure in an interior of the housing.

### CROSS-REFERENCE TO RELATED APPLICATIONS

The present invention claims priority under 35 U.S.C. § 119 to Japanese Application No. 2019-025798 filed on Feb. 15, 2019 the entire content of which is incorporated herein by reference.

### FIELD OF THE INVENTION

The present invention relates to a motor unit that has an internal pressure regulating function of regulating the pressure in an interior of a housing.

### BACKGROUND

A known driving unit used for an electric vehicle includes an electric motor, a power transmission system used for the electric vehicle to transfer power of the electric motor to a pair of left and right drive wheels, and a case arranged to contain the electric motor and the power transmission system used for the electric vehicle.

The case of the driving unit used for the electric vehicle is provided with a breather device to allow air to pass between an interior of the case and a space outside of the case to control an increase in the pressure in the interior thereof.

The breather device includes a breather body and an air hole passing through the case from the interior of the case to the space outside of the case. The air hole is defined in the case, but because the case is cylindrical, a process of defining the air hole therein is not easy, making it difficult to define the air hole at a desired position.

### SUMMARY

A motor unit according to a preferred embodiment of the present invention includes a motor including a rotor arranged to rotate about a motor axis, and a stator arranged opposite to the rotor; a housing arranged to house the motor; an inverter electrically connected to the motor; a busbar arranged to connect the motor and the inverter to each other; and a cover portion. The housing includes a motor housing portion arranged to house the motor, a top wall portion arranged to cover an upper side of the motor housing portion, and a work-use hole portion arranged to pass through the top wall portion. The cover portion is arranged to close an upper opening of the work-use hole portion. The cover portion includes a pressure regulating passage arranged to regulate a pressure in an interior of the housing.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram of a motor unit according to a preferred embodiment of the present invention.

FIG. 2 is a schematic side view of the motor unit according to a preferred embodiment of the present invention.

FIG. 3 is an enlarged sectional view of a portion of the motor unit indicated by “III” in FIG. 2, illustrating a section thereof perpendicular to a motor axis.

FIG. 4 is a perspective view of a portion of the motor unit, illustrating a first joining member fixed to an inverter case and its vicinity.

FIG. 5 is a perspective view of a portion of the motor unit, illustrating a work-use hole portion of a housing and its vicinity.

FIG. 6 is a perspective view of the first joining member and a second joining member fitted together.

FIG. 7 is a diagram illustrating the first joining member and the second joining member fitted together as viewed in a first direction.

FIG. 8 illustrates a modification of a preferred embodiment of the present invention illustrated in FIG. 7.

FIG. 9 is a perspective view of a cover portion according to a preferred embodiment of the present invention.

FIG. 10 is a sectional view of the cover portion taken along line A-A in FIG. 9.

### DETAILED DESCRIPTION

Hereinafter, motor units according to preferred embodiments of the present invention will be described with reference to the accompanying drawings. Note that the scope of the present invention is not limited to the preferred embodiments described below, but includes any modification thereof within the scope of the technical idea of the present invention.

The following description will be made with the direction of gravity being defined on the basis of positional relationships when a motor unit 1 is installed in a vehicle located on a horizontal road surface. In addition, in the drawings, an xyz coordinate system is shown appropriately as a three-dimensional orthogonal coordinate system. In the xyz coordinate system, a z-axis direction corresponds to a vertical direction (i.e., an up-down direction), and a +z direction points upward (i.e., in a direction opposite to the direction of gravity), while a −z direction points downward (i.e., in the direction of gravity). In addition, an x-axis direction corresponds to a front-rear direction of the vehicle in which the motor unit 1 is installed, and is a direction perpendicular to the z-axis direction, and a +x direction points forward of the vehicle, while a −x direction points rearward of the vehicle. Note, however, that the +x direction and the −x direction may point rearward and forward, respectively, of the vehicle. A y-axis direction is a direction perpendicular to both the x-axis direction and the z-axis direction, and corresponds to a width direction (i.e., a left-right direction) of the vehicle, and a +y direction points to the left side of the vehicle, while −y direction points to the right side of the vehicle. Note, however, that in the case where the +x direction points rearward of the vehicle, the +y direction and the −y direction may point to the right side and the left side, respectively, of the vehicle. That is, regardless of the direction of an x-axis, the +y direction points to one side of the vehicle in the left-right direction, while the −y direction points to another side of the vehicle in the left-right direction.

In the following description, unless otherwise specified, a direction (i.e., the y-axis direction) parallel to a motor axis J2 of a motor 2 will be simply referred to by the term “axial direction”, “axial”, or “axially”, radial directions centered on the motor axis J2 will be simply referred to by the term “radial direction”, “radial”, or “radially”, and a circumferential direction centered on the motor axis J2, i.e., a circumferential direction about the motor axis J2, will be simply referred to by the term “circumferential direction”, “circumferential”, or “circumferentially”. Note, however, that the term “parallel” as used above includes both “parallel” and “substantially parallel”. When two straight lines are “substantially parallel” to each other, one of the straight lines is angled at less than 450 with respect to the other straight line.

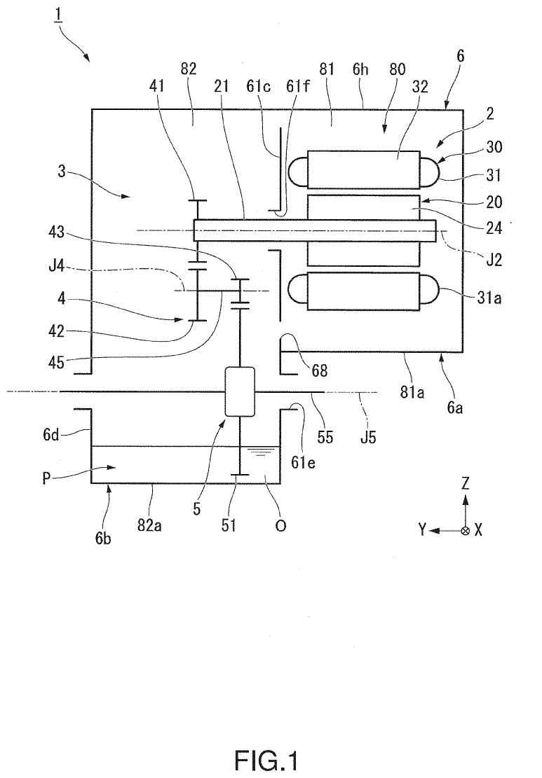

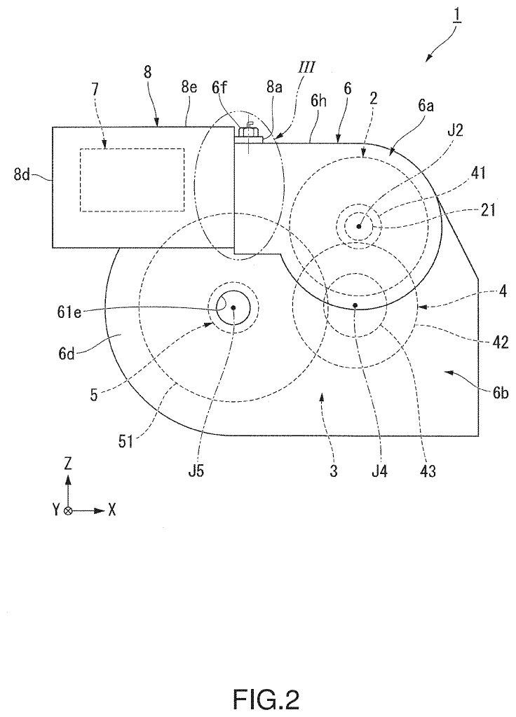

A motor unit (i.e., an electric drive machine) 1 according to a preferred embodiment of the present invention will be described below. FIG. 1 is a schematic diagram of the motor unit 1 according to a preferred embodiment. FIG. 2 is a schematic side view of the motor unit 1 as viewed from the side of the vehicle. Note that FIG. 1 is merely a schematic diagram, and does not necessarily represent actual arrangements and dimensions of members and portions of the motor unit 1.

The motor unit 1 is installed in a vehicle having a motor as a power source, such as, for example, a hybrid electric vehicle (HEV), a plug-in hybrid vehicle (PHV), or an electric vehicle (EV), and is used as the power source thereof.

Referring to FIGS. 1, 2, 3, 4, and 5, the motor unit 1 according to the present preferred embodiment includes a motor (i.e., a main motor) 2, a gear portion 3, a housing 6, an inverter 7, an inverter case 8, fixing members 6f, busbars 9, wiring screw portions 18, a cover portion 17, a first joining member 10, nut portions 19, a second joining member 14, a first seal portion 11, a second seal portion 12, a third seal portion 13, first screw members 15, and second screw members 16. The motor axis J2 of the motor 2 extends in a direction perpendicular to a first direction (which corresponds to the x-axis direction in the present preferred embodiment), which will be described below. The motor axis J2 extends in the y-axis direction.

The motor 2 includes a rotor 20 arranged to rotate about the motor axis J2, and a stator 30 arranged opposite to the rotor 20. The stator 30 is arranged radially opposite to the rotor 20. A housing space 80, in which the motor 2 and the gear portion 3 are housed, is defined in an interior of the housing 6. The housing space 80 is divided into a motor chamber 81 arranged to house the motor 2, and a gear chamber 82 arranged to house the gear portion 3.

The motor 2 is housed in the motor chamber 81 of the housing 6. The motor 2 includes the rotor 20 and the stator 30, which is arranged opposite to the rotor 20 on a radially outer side thereof. That is, the stator 30 according to the present preferred embodiment is located radially outside of the rotor 20. The motor 2 according to the present preferred embodiment is an inner-rotor motor including the stator 30 and the rotor 20, which is arranged to be rotatable inside of the stator 30.

The rotor 20 is caused to rotate by power being supplied from a battery (not shown) to the stator 30 through the inverter 7. The rotor 20 includes a shaft (i.e., a motor shaft) 21, a rotor core 24, and rotor magnets (not shown). The rotor 20 (i.e., the shaft 21, the rotor core 24, and the rotor magnets) is arranged to rotate about the motor axis J2, which extends in a horizontal direction. A torque of the rotor 20 is transferred to the gear portion 3.

The shaft 21 is arranged to extend with the motor axis J2, which extends in the horizontal direction and the width direction of the vehicle, as a center. The shaft 21 is arranged to rotate about the motor axis J2. The shaft 21 is a hollow shaft including an internal hollow portion with an inner circumferential surface thereof extending along the motor axis J2.

The shaft 21 is arranged to extend over both the motor chamber 81 and the gear chamber 82 of the housing 6. One end portion of the shaft 21 is arranged to project into the gear chamber 82. A first gear 41 is fixed to the end portion of the shaft 21 arranged to project into the gear chamber 82.

The rotor core 24 is defined by laminated silicon steel sheets. The rotor core 24 is a columnar body arranged to extend along an axial direction. The rotor magnets are fixed to the rotor core 24. The rotor magnets are arranged along a circumferential direction with alternating magnetic poles.

The stator 30 is arranged to surround the rotor 20 from radially outside. The stator 30 includes a stator core 32, coils 31, an insulator (not shown) arranged between the stator core 32 and the coils 31, and wiring members 33 arranged to connect the coils 31 to the busbars 9. The stator 30 is held by the housing 6. The stator core 32 includes a yoke in the shape of a circular ring, and a plurality of magnetic pole teeth arranged to extend radially inward from an inner circumferential surface of the yoke, which are not shown in the figures. Coil wires (not shown) are wound around the magnetic pole teeth. The coil wires wound around the magnetic pole teeth define the coils 31. The coil wires are connected to the inverter 7 through the wiring members 33 and the busbars 9. The coils 31 have coil ends 31a arranged to project from axial end surfaces of the stator core 32. The coil ends 31a are arranged to project in the axial direction relative to end portions of the rotor core 24 of the rotor 20. The coil ends 31a are arranged to project to both sides in the axial direction relative to the rotor core 24.

The gear portion 3 is housed in the gear chamber 82 of the housing 6. The gear portion 3 is connected to the shaft 21 on a first side in the axial direction of the motor axis J2. The gear portion 3 includes a reduction gear 4 and a differential 5. A torque outputted from the motor 2 is transferred to the differential 5 through the reduction gear 4.

The reduction gear 4 is connected to the rotor 20 of the motor 2. The reduction gear 4 has a function of increasing the torque outputted from the motor 2 in accordance with a reduction ratio while reducing the rotation speed of the motor 2. The reduction gear 4 is arranged to transfer the torque outputted from the motor 2 to the differential 5.

The reduction gear 4 includes the first gear (i.e., an intermediate drive gear) 41, a second gear (i.e., an intermediate gear) 42, a third gear (i.e., a final drive gear) 43, and an intermediate shaft 45. The torque outputted from the motor 2 is transferred to a ring gear (i.e., a gear) 51 of the differential 5 through the shaft 21 of the motor 2, the first gear 41, the second gear 42, the intermediate shaft 45, and the third gear 43. The number of gears, the gear ratios of the gears, and so on can be modified in various manners in accordance with a desired reduction ratio. The reduction gear 4 is a speed reducer of a parallel-axis gearing type, in which center axes of gears are arranged in parallel with each other.

The first gear 41 is arranged on an outer circumferential surface of the shaft 21 of the motor 2. The first gear 41 is arranged to rotate about the motor axis J2 together with the shaft 21. The intermediate shaft 45 is arranged to extend along an intermediate axis J4 parallel to the motor axis J2. The intermediate shaft 45 is arranged to rotate about the intermediate axis J4. Each of the second gear 42 and the third gear 43 is arranged on an outer circumferential surface of the intermediate shaft 45. The second gear 42 and the third gear 43 are connected to each other through the intermediate shaft 45. Each of the second gear 42 and the third gear 43 is arranged to rotate about the intermediate axis J4. The second gear 42 is arranged to mesh with the first gear 41. The third gear 43 is arranged to mesh with the ring gear 51 of the differential 5. The third gear 43 is located on a side of the second gear 42 on which a partition 61c lies (i.e., on a second side of the second gear 42 in the axial direction of the motor axis J2).

The differential 5 is connected to the motor 2 through the reduction gear 4. The differential 5 is a device arranged to transfer the torque outputted from the motor 2 to wheels of the vehicle. The differential 5 has a function of transferring the same torque to axles 55 of left and right wheels while absorbing a difference in speed between the left and right wheels when the vehicle is turning. The differential 5 includes the ring gear 51, a gear housing (not shown), a pair of pinion gears (not shown), a pinion shaft (not shown), and a pair of side gears (not shown).

The ring gear 51 is arranged to rotate about a differential axis J5 parallel to the motor axis J2. The torque outputted from the motor 2 is transferred to the ring gear 51 through the reduction gear 4. That is, the ring gear 51 is connected to the motor 2 with other gears intervening therebetween. The ring gear 51 is arranged to have the greatest outside diameter of all the gears of the gear portion 3.

The motor axis J2, the intermediate axis J4, and the differential axis J5 extend in parallel with one another along the horizontal direction. Referring to FIG. 2, each of the intermediate axis J4 and the differential axis J5 is located lower than the motor axis J2 when viewed in the axial direction of the motor axis J2. Accordingly, each of the reduction gear 4 and the differential 5 is located lower than the motor 2. The intermediate axis J4 and the differential axis J5 are arranged at substantially the same position in the up-down direction. Note that this is not essential to the present invention, and that the differential axis J5 may alternatively be arranged at a higher position in the up-down direction than the intermediate axis J4. In this case, a reduction in the external dimension of the motor unit 1 in the up-down direction can be achieved. Note that the differential axis J5 may alternatively be arranged at a lower position in the up-down direction than the intermediate axis J4.

The housing 6 is made of, for example, a metal, such as an aluminum alloy. Although not illustrated in the figures, the housing 6 is defined by a combination of a plurality of members. Note that the housing 6 may alternatively by defined by a single monolithic member. Referring to FIG. 1, the motor 2 and the gear portion 3 are housed in the housing space 80 defined in the interior of the housing 6. The housing 6 is arranged to hold the motor 2 and the gear portion 3 in the housing space 80. The housing 6 includes the partition 61c. The housing space 80 of the housing 6 is divided by the partition 61c into the motor chamber 81 and the gear chamber 82. The motor 2 is housed in the motor chamber 81. The gear portion 3 (i.e., the reduction gear 4 and the differential 5) is housed in the gear chamber 82.

An oil pool P, i.e., a pool of an oil O, is arranged in a lower region in the housing space 80. In the present preferred embodiment, a bottom portion 81a of the motor chamber 81 is located higher than a bottom portion 82a of the gear chamber 82. In addition, a partition opening 68 is defined in the partition 61c, which is arranged to divide the motor chamber 81 and the gear chamber 82. The partition opening 68 is arranged to bring the motor chamber 81 and the gear chamber 82 into communication with each other. The partition opening 68 allows a portion of the oil O which has been gathered in a lower region in the motor chamber 81 to be transferred to the gear chamber 82 therethrough. In addition to the aforementioned partition opening 68, an insert hole 61f, through which the shaft 21 of the motor 2 is inserted, is defined in the partition 61c.

A portion of the differential 5 soaks in the oil pool P. The oil O gathered in the oil pool P is scraped up by an operation of the differential 5, and a portion thereof is spread within the gear chamber 82. The portion of the oil O which has been spread within the gear chamber 82 is fed to various gears of the differential 5 and the reduction gear 4 within the gear chamber 82, so that the oil O spreads throughout tooth faces of the gears. Portions of the oil O which have been used by the reduction gear 4 and the differential 5 drip, and are collected into the oil pool P in a lower region of the gear chamber 82. The oil pool P in the housing space 80 has such a capacity that a portion of a bearing of the differential 5 will soak in the oil O when the motor unit 1 is at rest.

The oil O is arranged to circulate in an oil passage (not shown) arranged in the housing 6. The oil passage is a channel of the oil O along which the oil O is fed from the oil pool P to the motor 2. The oil passage is arranged to circulate the oil O to cool the motor 2.

The oil O is used to lubricate the reduction gear 4 and the differential 5. In addition, the oil O is used to cool the motor 2. The oil O is gathered in the lower region (i.e., the oil pool P) in the gear chamber 82. An oil equivalent to a lubricating oil (ATF: Automatic Transmission Fluid) for an automatic transmission having a low viscosity is preferably used as the oil O so that the oil O can perform functions of a lubricating oil and a cooling oil.

Referring to FIGS. 1 and 2, the housing 6 includes a motor housing portion 6a arranged to house the motor 2, and a gear housing portion 6b arranged to house the gear portion 3. That is, the motor 2 is housed in the housing 6. The motor housing portion 6a is substantially cylindrical, and is centered on the motor axis J2.

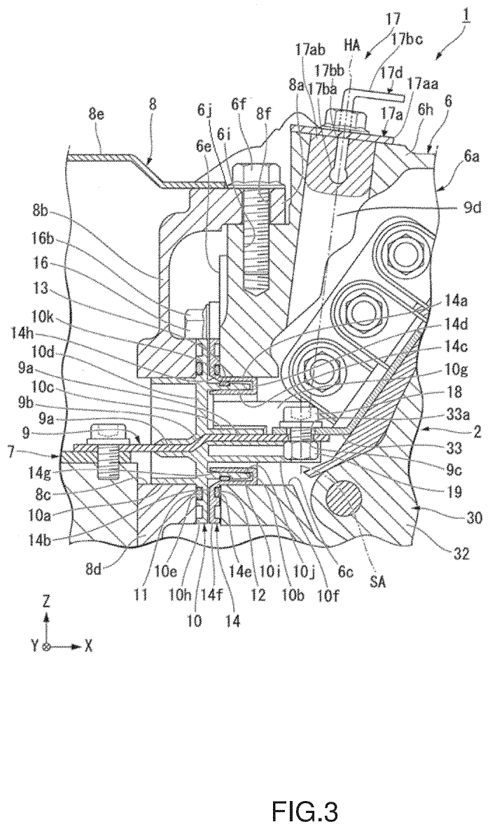

Referring to FIG. 3, the motor housing portion 6a includes a wall portion 6e arranged opposite to the inverter case 8, a second opening hole 6c arranged to pass through the wall portion 6e in the x-axis direction, a top wall portion 6h arranged to cover an upper side of the motor housing portion 6a, and a work-use hole portion 6j arranged to pass through the top wall portion 6h substantially in the z-axis direction. That is, the housing 6 includes the second opening hole 6c and the work-use hole portion 6j.

The second opening hole 6c is arranged in the wall portion 6e to open in the x-axis direction. The second opening hole 6c is arranged to pass through the wall portion 6e substantially in a radial direction. Although not illustrated in the figures, the second opening hole 6c is elliptical when viewed in the x-axis direction. The second opening hole 6c is in the shape of an ellipse, being elongated in the y-axis direction. That is, the second opening hole 6c has a greater opening dimension (i.e., diameter) in the y-axis direction than in the z-axis direction when viewed in the x-axis direction.

The work-use hole portion 6j is arranged in the top wall portion 6h to open substantially in the z-axis direction. Although not illustrated in the figures, the work-use hole portion 6j is elliptical when viewed in the z-axis direction. The work-use hole portion 6j is in the shape of an ellipse, being elongated in the y-axis direction. That is, the work-use hole portion 6j has a greater opening dimension (i.e., diameter) in the y-axis direction than in the x-axis direction when viewed in the z-axis direction. A tool used for work or the like is inserted into the housing 6 through the work-use hole portion 6j.

Referring to FIG. 2, the gear housing portion 6b includes a protruding portion 6d arranged to protrude radially relative to the motor housing portion 6a when viewed in the axial direction. In the present preferred embodiment, the protruding portion 6d is arranged to protrude downward and toward a rear side of the vehicle relative to the motor housing portion 6a. The protruding portion 6d is arranged to house portions of the gear portion 3. Specifically, a portion of the second gear 42, a portion of the third gear 43, and a portion of the ring gear 51 are housed in the protruding portion 6d. Axle insertion holes 61e are defined in the protruding portion 6d. Each axle insertion hole 61e is arranged to pass through the protruding portion 6d in the y-axis direction. Referring to FIG. 1, each axle insertion hole 61e is defined in a separate one of a pair of wall portions located at both end portions of the protruding portion 6d in the y-axis direction. A corresponding one of the axles 55 is inserted through each axle insertion hole 61e.

The inverter 7 is electrically connected to the motor 2. The inverter 7 is arranged to supply power to the motor 2. The inverter 7 is electrically connected to the stator 30 through the busbars 9 to supply the power to the stator 30. The inverter 7 is arranged to control supply of an electric current to the motor 2. The inverter 7 includes a circuit board and capacitors.

Referring to FIG. 2, the inverter case 8 is a container substantially in the shape of a rectangular parallelepiped. The inverter case 8 is made of, for example, a metal, such as an aluminum alloy. Note that the inverter case 8 may alternatively be made of a resin. The inverter 7 is housed in the inverter case 8. The inverter case 8 is arranged adjacent to the motor housing portion 6a in a radial direction with respect to the motor axis J2. The inverter case 8 and the motor housing portion 6a are arranged adjacent to each other in a horizontal direction. The inverter case 8 includes a case body 8d having a bottom and being tubular, and a case cover portion 8e arranged to close an upper opening of the case body 8d.

Referring to FIG. 3, the case body 8d includes a wall portion 8b arranged opposite to the motor housing portion 6a, a first opening hole 8c arranged to pass through the wall portion 8b in the x-axis direction, and case collar portions 8a. That is, the inverter case 8 includes the first opening hole 8c.

The first opening hole 8c is arranged in the wall portion 8b to open in the x-axis direction. The first opening hole 8c is arranged to pass through the wall portion 8b substantially in a radial direction. Although not illustrated in the figures, the first opening hole 8c is elliptical when viewed in the x-axis direction. The first opening hole 8c is in the shape of an ellipse, being elongated in the y-axis direction. That is, the first opening hole 8c has a greater opening dimension (i.e., diameter) in the y-axis direction than in the z-axis direction when viewed in the x-axis direction.

The first opening hole 8c is arranged opposite to the second opening hole 6c in the first direction (which corresponds to the x-axis direction in the present preferred embodiment), which will be described below. That is, the second opening hole 6c is opposite to the first opening hole 8c in the first direction. In the example of the present preferred embodiment, a section of the first opening hole 8c perpendicular to the x-axis and a section of the second opening hole 6c perpendicular to the x-axis are arranged to have substantially the same shape and size. When viewed in the x-axis direction, the shape and size (i.e., contour) of the first opening hole 8c and the shape and size of the second opening hole 6c are substantially identical to each other.

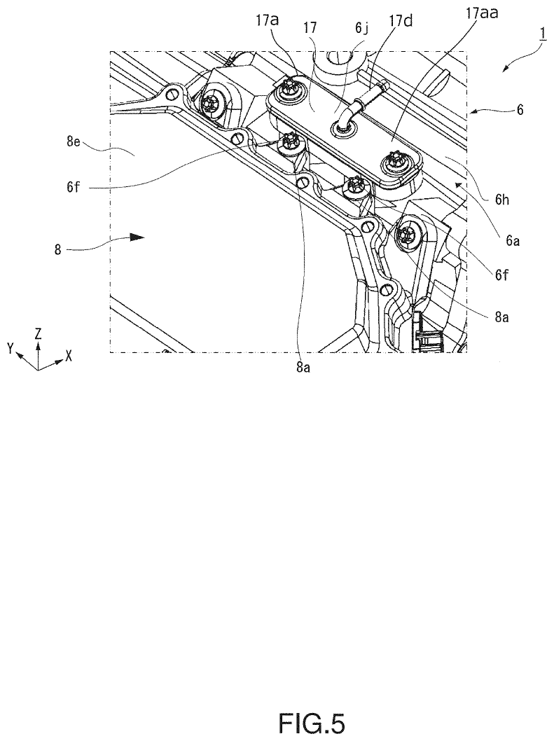

Each case collar portion 8a is the shape of a plate, and is arranged to project in the x-axis direction from an upper end portion of the wall portion 8b. In the example of the present preferred embodiment, the case collar portions 8a are arranged at regular intervals in the y-axis direction at the upper end portion of the wall portion 8b (see FIG. 5). Principal surfaces of each case collar portion 8a are arranged to face in the z-axis direction. The case collar portion 8a includes a screw insert hole 8f arranged to pass through the case collar portion 8a in the z-axis direction.

One of the fixing members 6f is inserted into each screw insert hole 8f. In the present preferred embodiment, each fixing member 6f is a screw member, such as, for example, a bolt. The fixing member 6f is arranged to extend in the z-axis direction. The fixing member 6f is screwed into a screw hole 6i in the top wall portion 6h of the motor housing portion 6a. The screw hole 6i is defined in the top wall portion 6h, and is arranged to open upward. The fixing member 6f is screwed into the housing 6 in the z-axis direction. The number of fixing members 6f is more than one. The fixing members 6f are inserted into the respective screw insert holes 8f, which are arranged at regular intervals in the y-axis direction. The inverter case 8 is fixed to the housing 6 through the fixing members 6f and so on. That is, the fixing members 6f are arranged to fix the inverter case 8 and the housing 6 to each other. The inverter case 8 is fixed to an outer peripheral surface of the motor housing portion 6a which faces radially outward.

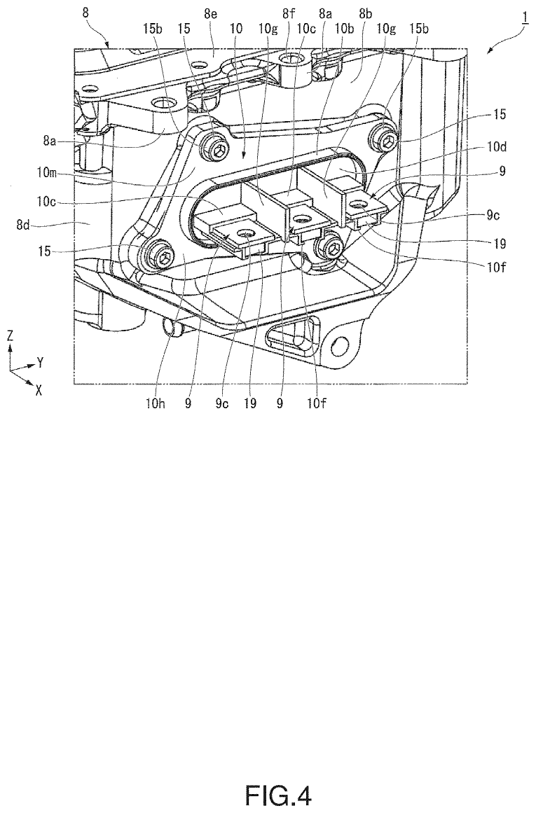

The busbars 9 are arranged to connect the motor 2 and the inverter 7 to each other. The busbars 9 are arranged to electrically connect the stator 30 and the inverter 7 to each other. In the present preferred embodiment, each busbar 9 is in the shape of a plate. A pair of principal surfaces (i.e., a front surface and a rear surface) of each busbar 9 are arranged to face in the z-axis direction. Note that each busbar 9 may alternatively be in the shape of, for example, a stick having a circular section or the like. Referring to FIG. 4, the number of busbars 9 is more than one. The busbars 9 are arranged apart from one another in a direction perpendicular to the first direction (i.e., the x-axis direction), which will be described below. In the present preferred embodiment, the plurality (i.e., three) of busbars 9 are arranged side by side in a third direction (i.e., the y-axis direction), which will be described below. Electric currents passing in the three busbars 9 are different in phase. The phases of the electric currents passing in the three busbars 9 are a U phase, a V phase, and a W phase, respectively.

The number of wiring members 33 of the stator 30 is equal to the number of busbars 9, and is more than one in the present preferred embodiment. The wiring members 33 are arranged in an electrical connection chamber 9d of the housing 6. Accordingly, at least a portion of each busbar 9 is located in the electrical connection chamber 9d. The electrical connection chamber 9d is a space surrounded by an inner peripheral surface of the housing 6 and an outer peripheral surface of the stator 30. A portion of the inner peripheral surface of the housing 6 which defines an outer peripheral surface of the electrical connection chamber 9d is located radially outward of a portion of the inner peripheral surface of the housing 6 which has a shape matching that of the stator 30. In addition, the electrical connection chamber 9d is arranged on the upper side of the motor axis J2 in a second direction (i.e., the z-axis direction) and radially outside of the stator 30. The work-use hole portion 6j is arranged to be in communication with the electrical connection chamber 9d. That is, the electrical connection chamber 9d is arranged to be in communication with a space outside of the housing 6 through the work-use hole portion 6j. Although not illustrated in the figures, the wiring members 33 are arranged apart from one another in a direction perpendicular to the first direction (i.e., the x-axis direction). Three of the wiring members 33 are arranged side by side in the y-axis direction. The wiring members 33 are wiring members of the motor 2. The wiring members 33 are wiring members different from the busbars 9. Each wiring member 33 is, for example, a plate-shaped busbar. That is, each wiring member 33 is in the shape of a plate. The wiring members 33 are electrically connected to the corresponding busbars 9. A principal surface of each wiring member 33 is arranged to be in contact with the corresponding principal surface of the corresponding busbar 9. That is, each wiring member 33 is arranged to be in contact with the corresponding busbar 9.

Referring to FIG. 3, each busbar 9 includes a pair of first extending portions 9a, a second extending portion 9b, and a through hole 9c. Each first extending portion 9a is a portion of the busbar 9 which is arranged to extend in the first direction. The second extending portion 9b is a portion of the busbar 9 which is arranged to extend in a direction different from the first direction. That is, the busbar 9 includes portions extending in the first direction, and a portion extending in a direction different from the first direction. The “direction different from the first direction” is a direction that is not parallel to the first direction. In the present preferred embodiment, the pair of first extending portions 9a are arranged apart from each other in the busbar 9. The second extending portion 9b is arranged between the pair of first extending portions 9a to join the pair of first extending portions 9a to each other. In the present preferred embodiment, the first direction is the x-axis direction. Each first extending portion 9a is arranged to extend in the x-axis direction. The second extending portion 9b is arranged to slant in the z-axis direction while extending in the x-axis direction.

In the following description, in the first direction, a side on which the second opening hole 6c lies with respect to the first opening hole 8c will be referred to as a first side in the first direction. Specifically, the first side in the first direction corresponds to the +x direction. In the first direction, a side on which the first opening hole 8c lies with respect to the second opening hole 6c will be referred to as a second side in the first direction. Specifically, the second side in the first direction corresponds to the −x direction. In addition, the up-down direction, which is a direction perpendicular to the first direction, will be referred to as the second direction. That is, the second direction is perpendicular to the first direction. The second direction corresponds to the z-axis direction. In addition, the left-right direction, which is a direction perpendicular to the first direction, will be referred to as the third direction. The third direction corresponds to the y-axis direction. One of the first direction, the second direction, and the third direction is perpendicular to each of the other two directions.

The busbars 9 are passed through the first opening hole 8c. Each busbar 9 is arranged to extend over both spaces inside and outside of the inverter case 8 through the first opening hole 8c. An end portion of the busbar 9 on the first side in the first direction projects to the first side in the first direction relative to the first opening hole 8c. That is, the end portion of the busbar 9 on the first side in the first direction is located outside of the inverter case 8. An end portion of the busbar 9 on the second side in the first direction projects to the second side in the first direction relative to the first opening hole 8c. That is, the end portion of the busbar 9 on the second side in the first direction is located inside of the inverter case 8. The busbar 9 is supported by the first joining member 10, which will be described below. The busbar 9 is fixed to the inverter case 8 through the first joining member 10.

The busbars 9 are passed through the second opening hole 6c. The busbars 9 are passed through the second opening hole 6c with the busbars 9 being fixed to the inverter case 8. The busbars 9 are inserted through the second opening hole 6c. Each busbar 9 is arranged to extend over both spaces inside and outside of the motor housing portion 6a (i.e., the housing 6) through the second opening hole 6c. An end portion of the busbar 9 on the first side in the first direction projects to the first side in the first direction relative to the second opening hole 6c. That is, the end portion of the busbar 9 on the first side in the first direction is located inside of the housing 6. An end portion of the busbar 9 on the second side in the first direction projects to the second side in the first direction relative to the second opening hole 6c. That is, the end portion of the busbar 9 on the second side in the first direction is located outside of the housing 6. The busbars 9 are passed through the second joining member 14, which will be described below, to be inserted into the housing 6. The busbars 9 are inserted inside of a tubular guide portion 14a, which will be described below, of the second joining member 14.

In the present preferred embodiment, the one of the pair of first extending portions 9a which is located on the first side in the first direction is arranged to overlap with the second opening hole 6c when viewed in a direction perpendicular to the first direction. Each of the other one of the pair of first extending portions 9a which is located on the second side in the first direction and the second extending portion 9b is arranged to overlap with the first opening hole 8c when viewed in a direction perpendicular to the first direction.

The through hole 9c is defined in each busbar 9. The through hole 9c is arranged to pass through the busbar 9 in the z-axis direction to open in the pair of principal surfaces of the busbar 9. The through hole 9c is arranged in an end portion of the busbar 9 on the first side in the first direction. The through hole 9c is defined in the one of the pair of first extending portions 9a which is located on the first side in the first direction.

The through hole 9c is arranged to overlap with a through hole 33a of the corresponding wiring member 33 when viewed in the z-axis direction. The wiring screw portion 18 is passed through the through hole 9c and the through hole 33a. The wiring screw portion 18 is a screw member arranged to extend in the z-axis direction. The wiring screw portion 18 is screwed into the corresponding nut portion 19, which will be described below. The busbar 9 and the wiring member 33 are fixed to each other by being held between the wiring screw portion 18 and the nut portion 19 in the z-axis direction. That is, the wiring screw portion 18 connects the busbar 9 and the wiring member 33 of the motor 2 to each other. The busbar 9 and the wiring member 33 are connected to each other in the electrical connection chamber 9d.

A screw axis SA of each wiring screw portion 18 extends in a direction perpendicular to the first direction. Specifically, the screw axis SA extends in the second direction (i.e., the z-axis direction). According to the present preferred embodiment, each busbar 9 and the corresponding wiring member 33 of the motor 2 can be connected to each other without complicating the structure of the busbars 9. Note that the screw axis SA of each wiring screw portion 18 may alternatively extend along a central axis HA of the work-use hole portion 6j, which will be described below. In this case, a pair of principal surfaces of the end portion of each busbar 9 on the first side in the first direction are arranged to face in a direction along the central axis HA, with the through hole 9c opening in the direction along the central axis HA. In this case, the screwing of each wiring screw portion 18 using the tool used for work or the like can be stably performed through the work-use hole portion 6j.

One of the fixing members 6f and one of the busbars 9 are arranged to overlap with each other when viewed in a direction perpendicular to the first direction. Specifically, the fixing member 6f and the busbar 9 are arranged to overlap with each other when viewed in the second direction (i.e., the z-axis direction). The fixing member 6f and the one of the first extending portions 9a which is located on the first side in the first direction are arranged to overlap with each other when viewed in the second direction.

The work-use hole portion 6j of the housing 6 is arranged to open toward each busbar 9. The work-use hole portion 6j is arranged to open toward the one of the pair of first extending portions 9a which is located on the first side in the first direction. The work-use hole portion 6j is arranged to open toward the through holes 9c in the housing 6. According to the present preferred embodiment, it is possible to connect each busbar 9 and the corresponding wiring member 33 to each other in the interior of the housing 6 by, using the tool used for work or the like, inserting the wiring screw portion 18 into the through hole 9c of the busbar 9 through the work-use hole portion 6j, and screwing the wiring screw portion 18 into the nut portion 19.

The work-use hole portion 6j is arranged to slant in the first direction while extending in a direction (which is the second direction in the present preferred embodiment) perpendicular to the first direction. The work-use hole portion 6j is arranged to slant to the second side in the first direction while extending closer to the busbars 9 in the direction perpendicular to the first direction (i.e., while extending downward in the present preferred embodiment). That is, the central axis HA of the work-use hole portion 6j slants in the first direction while extending in the direction perpendicular to the first direction. The central axis HA slants to the second side in the first direction while extending closer to the busbars 9 in the direction perpendicular to the first direction.

According to the present preferred embodiment, the inverter case 8 and the housing 6 can be stably fixed to each other through the fixing members 6f arranged at regular intervals in the third direction (i.e., the y-axis direction). In addition, each busbar 9 and the corresponding wiring member 33 of the motor 2 can be connected to each other in the housing 6 through the tool used for work or the like inserted into the work-use hole portion 6j. Since the work-use hole portion 6j is arranged to extend toward the busbars 9 at an angle to the second direction, it is possible to connect each busbar 9 and the corresponding wiring member 33 to each other without deteriorating the condition of fixing (i.e., strength of fixing) between the inverter case 8 and the housing 6 through the fixing members 6f.

In more detail, unlike the present preferred embodiment, a case where the work-use hole portion 6j extends along the second direction (i.e., the z-axis direction), for example, involves the following problem. It may be impossible to arrange the fixing members 6f to overlap with the busbars 9 when viewed in the second direction. That is, if priority is placed on the arrangement of the work-use hole portion 6j, it may become impossible to arrange the fixing members 6f at desired positions, resulting in an unstable condition (i.e., an insufficient strength) of the fixing between the inverter case 8 and the housing 6. On the other hand, if priority is placed on the arrangement of the fixing members 6f to ensure a sufficient strength of the fixing between the inverter case 8 and the housing 6, it may become necessary to shift the work-use hole portion 6j and the busbars 9 to positions that do not overlap with the fixing members 6f when viewed in the second direction. This will result in an increase in the external dimension of the motor unit 1 in the third direction (i.e., the axial direction of the motor axis J2). In addition, a reduced flexibility in the arrangement of members of the motor unit 1 will result. In contrast, the present preferred embodiment is able to achieve reduced external dimensions of the motor unit 1 and ensure sufficient flexibility in the arrangement of the members while allowing the fixing members 6f to be arranged at desired positions to stabilize the condition (i.e., ensure a sufficient strength) of the fixing between the inverter case 8 and the housing 6. In addition, in the present preferred embodiment, each busbar 9 can be connected to the corresponding wiring member 33 of the motor 2 using the work-use hole portion 6j. In the present preferred embodiment, it is easy to arrange the work-use hole portion 6j in the housing 6 since the work-use hole portion 6j is a slanting hole that slants to the second side in the first direction while extending closer to the busbars 9 along the second direction.

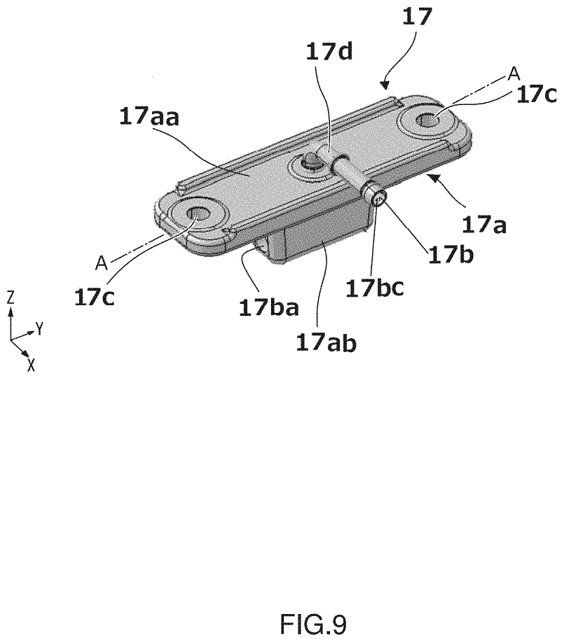

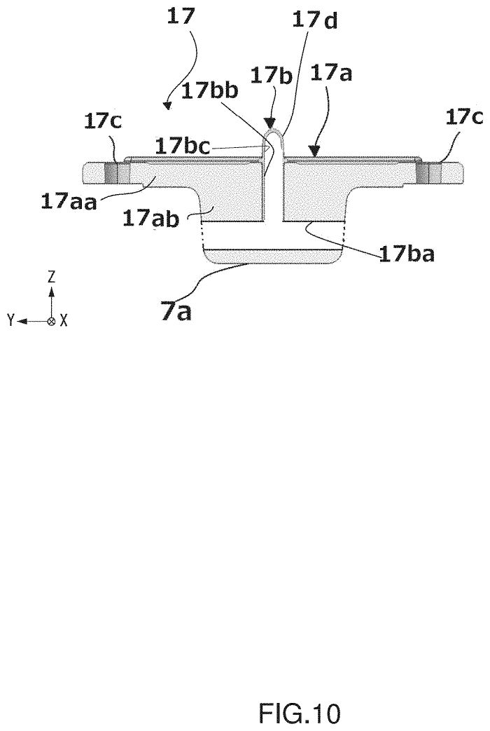

FIG. 9 is a perspective view illustrating the cover portion 17. FIG. 10 is a sectional view of the cover portion 17 taken along line A-A in FIG. 9. The cover portion 17 illustrated in FIGS. 3, 5, 9, and 10 includes a body portion 17a and a pipe portion 17d arranged to project upward from the body portion 17a. The body portion 17a includes a flange portion 17aa and a projecting portion 17ab arranged to project from the flange portion 17aa toward the busbars 9. The flange portion 17aa as a whole is in the shape of a plate, and is substantially in the shape of a rectangle in a plan view, with a major axis extending in the third direction (i.e., the y-axis direction) and a minor axis extending in the first direction (i.e., the x-axis direction). The flange portion 17aa of the cover portion 17 is arranged to close the work-use hole portion 6j. Further, the projecting portion 17ab is arranged to be inserted into the work-use hole portion 6j.

The cover portion 17 includes a pressure regulating passage 17b arranged to regulate the pressure in the interior of the housing 6. The pressure regulating passage 17b is defined in the body portion 17a and the pipe portion 17d. The pressure regulating passage 17b includes a first passage 17ba, a second passage 17bb, and a third passage 17bc. The first passage 17ba is defined in the projecting portion 17ab of the body portion 17a, and is arranged to pass through the projecting portion 17ab with both end portions of the first passage 17ba opening in the third direction (i.e., the y-axis direction). The second passage 17bb is defined in the projecting portion 17ab and the flange portion 17aa of the body portion 17a. The second passage 17bb is joined to the first passage 17ba in the second direction (i.e., the z-axis direction). Preferably, the second passage 17bb is a through hole arranged to extend upward in the second direction (i.e., the z-axis direction) from a substantial middle of the first passage 17ba in the third direction (i.e., the y-axis direction). Note that the second passage 17bb may alternatively be displaced toward either end portion of the first passage 17ba in the third direction (i.e., the y-axis direction) of the first passage 17ba. One end of the second passage 17bb is joined to the first passage 17ba, while another end of the second passage 17bb is arranged to open to the upper side of the body portion 17a in the second direction (i.e., the z-axis direction) to be joined to the third passage 17bc. The first passage 17ba and the second passage 17bb together substantially assume the shape of the letter “T”. Thus, a bent channel is defined by the first passage 17ba and the second passage 17bb. This contributes to preventing the oil O in the interior of the housing 6 from flowing out through the pressure regulating passage 17b. In the projecting portion 17ab, the first passage 17ba is arranged to extend in a direction perpendicular to the direction in which the work-use hole portion 6j extends. This contributes to more effectively preventing the oil O in the interior of the housing 6 from flowing out through the pressure regulating passage 17b.

The third passage 17bc is defined by the pipe portion 17d. The third passage 17bc is arranged to extend upward in the second direction (i.e., the z-axis direction) and then in the first direction (i.e., the x-axis direction). One end of the third passage 17bc is connected to the second passage 17bb, while another end of the third passage 17bc is arranged to open to the atmosphere. Thus, the first passage 17ba, the second passage 17bb, and the third passage 17bc of the pressure regulating passage 17b are in communication with one another to bring the interior of the housing 6 into communication with the atmosphere.

The cover portion 17 is arranged to close an upper opening of the work-use hole portion 6j at the top wall portion 6h of the housing 6. The cover portion 17 is fixed to the housing 6 through screws. For example, the flange portion 17aa includes flange hole portions 17c, and the screws are inserted through the flange hole portions 17c to be fixed to the housing 6.

According to the present preferred embodiment, the cover portion 17 is located on one end side of the work-use hole portion 6j, while the busbars 9 are located on another end side of the work-use hole portion 6j. After performing a wiring operation on the busbars 9 through the work-use hole portion 6j, it is possible to close the work-use hole portion 6j with the cover portion 17. The cover portion 17 reduces the likelihood that a liquid, such as water, a foreign body, or the like will enter into the interior of the housing 6 through the work-use hole portion 6j. In addition, the cover portion 17 reduces the likelihood that the oil O or the like will leak out of the housing 6 from the interior of the housing 6. Further, opening of the pressure regulating passage 17b of the cover portion 17 will make the motor chamber 81 and the gear chamber 82 in the housing 6 open to the atmosphere. Thus, when the pressure in the motor chamber 81 and the gear chamber 82 has increased due to an increase in temperature or the like, air in the motor chamber 81 and the gear chamber 82 can be transferred into the atmosphere through the pressure regulating passage 17b to control an increase in the pressure in the interior of the housing 6.

In the present preferred embodiment, the pressure regulating passage 17b is arranged in the cover portion 17. That is, the pressure regulating passage 17b is independent of the housing 6. Accordingly, it is easy to perform a process of defining the pressure regulating passage 17b in the cover portion 17. In addition, the work-use hole portion 6j and a portion of the cover portion 17 are arranged in the electrical connection chamber 9d. Because the electrical connection chamber 9d is arranged on the upper side of a central axis of the stator 30 in the second direction (i.e., the z-axis direction) and radially outside thereof, the oil O does not easily reach the electrical connection chamber 9d. This leads to a reduction in the likelihood that the oil O in the interior of the housing 6 will intrude into the pressure regulating passage 17b located in the electrical connection chamber 9d. Note that the cover portion 17 and the housing 6 may be connected to each other through a sealing member, such as, for example, a gasket.

The first joining member 10 is made of a resin. The first joining member 10 is made of, for example, a PPS resin containing an elastomer component. The first joining member 10 is defined by a single monolithic member. The first joining member 10 is preferably made of, for example, a material having substantially the same thermal expansion coefficient (coefficient of thermal expansion) as that of the material of the busbars 9.

Referring to FIGS. 3 and 4, the first joining member 10 is attached to the inverter case 8 to close the first opening hole 8c. The first joining member 10 is attached to the wall portion 8b of the case body 8d to close an opening of the first opening hole 8c on the first side in the first direction. The first joining member 10 is arranged to be in contact with the inverter case 8 in the first direction. The first joining member 10 is fixed to the inverter case 8 through the first screw members 15, which will be described below. That is, the first joining member 10 is fixed to the inverter case 8 to close the first opening hole 8c. The first joining member 10 is located between the inverter case 8 and the housing 6 in the first direction, and is arranged at the first opening hole 8c.

Referring to FIGS. 3, 4, 6, and 7, the first joining member 10 is arranged to support the busbars 9. In the present preferred embodiment, the first joining member 10 is molded by a resin insert molding process together with portions of the busbars 9. The busbars 9 are fixed to the first joining member 10. In the first joining member 10, the busbars 9, of which there are a plurality, are arranged apart from one another in a direction (which is the third direction in the present preferred embodiment) perpendicular to the first direction. The busbars 9 are inserted into the second opening hole 6c of the housing 6 to be connected to the stator 30 of the motor 2.

Here, a method of manufacturing the motor unit 1 according to the present preferred embodiment will now be described below. The method of manufacturing the motor unit 1 includes a step of fixing the busbars 9 to the inverter case 8 by inserting the busbars 9 into the first opening hole 8c of the inverter case 8, in which the inverter 7 is housed, with portions of the busbars 9 projecting from an outer surface of the inverter case 8; a step of inserting portions of the busbars 9 into the second opening hole 6c of the housing 6, in which the motor 2 is housed; and a step of connecting the busbars 9 to the motor 2 inside of the housing 6. In the step of fixing the busbars 9 to the inverter case 8, the first joining member 10, which supports the busbars 9, is fixed to the inverter case 8 to close the first opening hole 8c with the first joining member 10. In the present preferred embodiment, in the step of fixing the busbars 9 to the inverter case 8, portions of the busbars 9 (i.e., portions of the busbars 9 which are located on the first side in the first direction) are arranged to project to the first side in the first direction from the wall portion 8b of the case body 8d. In the step of inserting the portions of the busbars 9, the portions of the busbars 9 are inserted toward the first side in the first direction into the second opening hole 6c. In the step of connecting the busbars 9 to the motor 2, the busbars 9 and the corresponding wiring members 33 of the stator 30 are connected to each other using the tool used for work or the like inserted through the work-use hole portion 6j. That is, the busbars 9 and the corresponding wiring members 33 are connected to each other with the wiring screw portions 18 and the nut portions 19 using the work-use hole portion 6j, which is open in the housing 6. The first opening hole 8c is arranged to overlap with the busbars 9 when viewed in the second direction. This arrangement facilitates a step of inserting the tool used for work or the like.

According to the present preferred embodiment, it is not necessary to open the inverter case 8 when the busbars 9 and the corresponding wiring members 33 of the motor 2 are connected to each other during assembly of the motor unit 1. That is, it is not necessary to remove the case cover portion 8e from the case body 8d. Accordingly, the likelihood that a foreign body, such as dust, or the like will enter into the inverter case 8 can be reduced by previously fixing the busbars 9 to the inverter case 8 in an environment where there is little dust, such as in a clean room, which leads to increased stability in performance of the inverter 7.

The first joining member 10 is arranged to be smaller in dimension in the second direction than in dimension in the third direction when viewed in the first direction. In other words, the first joining member 10 is arranged to extend in the third direction. According to the present preferred embodiment, the busbars 9 are arranged in the third direction, and accordingly, the first joining member 10 is arranged to be greater in external dimension in the third direction than in external dimension in the second direction. Thus, excessively large external dimensions (especially, an excessively large external dimension in the second direction) of the first joining member 10 can be avoided. This leads to a reduced cost of the material of the first joining member 10, and makes it easier to ensure sufficient strength of the fixing of the first joining member 10 to the inverter case 8.

The first joining member 10 includes a partition wall portion 10d, a tubular fitting portion 10a, a tubular insertion portion 10b, busbar fixing portions 10c, a first groove portion 10e, a first flange portion 10h, nut holding portions 10f, and insulating wall portions 10g.

The partition wall portion 10d is in the shape of a plate. The partition wall portion 10d is in the shape of a plate, extending perpendicularly to the first direction. The partition wall portion 10d is in the shape of an ellipse, being elongated in the third direction, when viewed in the first direction. The partition wall portion 10d is in the shape of an ellipse, with a major axis extending in the third direction and a minor axis extending in the second direction, when viewed in the first direction. An outer circumferential portion of the partition wall portion 10d is arranged opposite to an entire hole periphery of the first opening hole 8c in the wall portion 8b on the first side thereof in the first direction. In the present preferred embodiment, the “hole periphery of the first opening hole 8c” refers to an annular portion of the wall portion 8b which is arranged adjacent to an edge of the first opening hole 8c and which extends along the edge of the first opening hole 8c. The partition wall portion 10d is arranged to close the first opening hole 8c. The partition wall portion 10d is arranged to close the opening of the first opening hole 8c on the first side in the first direction. The partition wall portion 10d is arranged to overlap with the entire first opening hole 8c and cover the entire first opening hole 8c when viewed in the first direction. The partition wall portion 10d interrupts a communication between the first opening hole 8c and the second opening hole 6c.

The tubular fitting portion 10a is tubular, and is arranged to extend from the partition wall portion 10d to the second side in the first direction. The tubular fitting portion 10a is in the shape of an ellipse, being elongated in the third direction, when viewed in the first direction. The tubular fitting portion 10a is in the shape of an ellipse, with a major axis extending in the third direction and a minor axis extending in the second direction, when viewed in the first direction. The tubular fitting portion 10a is inserted into the first opening hole 8c. In the present preferred embodiment, the tubular fitting portion 10a is fitted into the first opening hole 8c. According to the present preferred embodiment, the first joining member 10 and the inverter case 8 are positioned and assembled through the tubular fitting portion 10a being fitted into the first opening hole 8c. Thus, positioning of the busbars 9 with respect to the inverter case 8 (e.g., a terminal block therein) can also be accurately accomplished. The first joining member 10 and the second joining member 14 can be fitted together with stable alignment, making it easier to connect the busbars 9 and the corresponding wiring members 33 of the motor 2 to each other. The busbars 9 are arranged apart from the tubular fitting portion 10a inside of the tubular fitting portion 10a when viewed in the first direction. The tubular fitting portion 10a provides insulation between a wall of the first opening hole 8c and the busbars 9.

Referring to FIGS. 3 and 4, in the present preferred embodiment, the insertion portion 10b is tubular, and is arranged to extend from the partition wall portion 10d to the first side in the first direction. The insertion portion 10b is in the shape of an ellipse, being elongated in the third direction, when viewed in the first direction. The insertion portion 10b is in the shape of an ellipse, with a major axis extending in the third direction and a minor axis extending in the second direction, when viewed in the first direction. The insertion portion 10b is inserted inside of the tubular guide portion 14a, which will be described below, of the second joining member 14. The insertion portion 10b includes an outer tapered surface 10i, an inner tapered surface 10j, and a third groove portion 10k. In FIG. 4, the third groove portion 10k is not shown.

The outer tapered surface 10i is arranged at an end portion of an outer circumferential surface of the tubular insertion portion 10b on the first side in the first direction. The outer tapered surface 10i is a slanting surface arranged to slant inward in the second opening hole 6c while extending to the first side in the first direction when viewed in the first direction. That is, referring to FIG. 3, the outer tapered surface 10i is arranged to slant toward an inner circumferential surface of the insertion portion 10b while extending to the first side in the first direction in a section taken along the first direction. According to the present preferred embodiment, it is easy to insert the insertion portion 10b inside of the tubular guide portion 14a because of the outer tapered surface 10i arranged at an end portion of the insertion portion 10b on the first side in the first direction. Accordingly, it is easy to fit the first joining member 10, which is attached to the inverter case 8, and the second joining member 14, which is attached to the housing 6, together.

The inner tapered surface 10j is arranged at an end portion of the inner circumferential surface of the tubular insertion portion 10b on the first side in the first direction. The inner tapered surface 10j is arranged to slant toward the outer circumferential surface of the insertion portion 10b while extending to the first side in the first direction in a section taken along the first direction. According to the present preferred embodiment, it is easy to fit the insertion portion 10b to an outside of an inner tubular portion 14c, which will be described below, of the second joining member 14 because of the inner tapered surface 10j arranged at the end portion of the insertion portion 10b on the first side in the first direction. Accordingly, it is easy to fit the first joining member 10, which is attached to the inverter case 8, and the second joining member 14, which is attached to the housing 6, together.

The third groove portion 10k is arranged at a portion of the outer circumferential surface of the insertion portion 10b which is opposite to an inner circumferential surface of the tubular guide portion 14a. In the present preferred embodiment, the third groove portion 10k is arranged in an intermediate portion of the outer circumferential surface of the insertion portion 10b, the intermediate portion lying between the end portion on the first side in the first direction and an end portion on the second side in the first direction. The third groove portion 10k is annular, and is arranged to extend along the outer circumferential surface of the insertion portion 10b when viewed in the first direction. The third groove portion 10k is in the shape of an ellipse, extending along the outer circumferential surface of the insertion portion 10b, when viewed in the first direction.

The number of busbar fixing portions 10c is equal to the number of busbars 9, and is more than one (specifically, three) in the present preferred embodiment. The three busbar fixing portions 10c are arranged side by side in the third direction. Each busbar fixing portion 10c includes a portion arranged to extend from the partition wall portion 10d to the first side in the first direction. The busbar fixing portion 10c includes a portion arranged to extend from the partition wall portion 10d to the second side in the first direction. The partition wall portion 10d holds the busbar fixing portions 10c. Each busbar fixing portion 10c is fixed to the partition wall portion 10d. The partition wall portion 10d interrupts a communication between the first opening hole 8c and the second opening hole 6c through a space inside of the tubular insertion portion 10b. In each busbar fixing portion 10c, a portion of the corresponding busbar 9 is buried and fixed. Specifically, a portion of each busbar 9 is buried and fixed in the corresponding busbar fixing portion 10c through, for example, an insert molding process with the busbars 9 as inserts. According to the present preferred embodiment, sufficient sealing between each busbar 9 and the corresponding busbar fixing portion 10c is ensured with the busbar 9 being closely adhered to the busbar fixing portion 10c. The busbar 9 is stably supported by the busbar fixing portion 10c. In addition, the partition wall portion 10d contributes to preventing the oil O or the like in the housing 6 from entering into the inverter case 8 through the second opening hole 6c and the first opening hole 8c. Sealing of the first opening hole 8c can be achieved with a simple structure.

In the present preferred embodiment, the second extending portion 9b of each busbar 9 and a portion of each of the pair of first extending portions 9a which is joined (adjacent) to the second extending portion 9b are buried in the corresponding busbar fixing portion 10c. That is, portions (i.e., the first extending portions 9a) of the busbar 9 which extend in the first direction and a portion (i.e., the second extending portion 9b) of the busbar 9 which extends in a direction different from the first direction are buried and fixed in the busbar fixing portion 10c. According to the present preferred embodiment, a reduction in the likelihood that each busbar 9 will move in the first direction relative to the corresponding busbar fixing portion 10c (i.e., will be detached) when, for example, an external force acting in the first direction is applied to the busbar 9 during the assembly of the motor unit 1 can be achieved. An increase in strength of fixing between each busbar 9 and the corresponding busbar fixing portion 10c can be achieved, ensuring stable sealing between the busbar 9 and the busbar fixing portion 10c.

The first groove portion 10e is defined in a surface of the first joining member 10 which is opposite to the inverter case 8. The first groove portion 10e is annular, surrounding the first opening hole 8c, when viewed in the first direction. The first groove portion 10e is in the shape of an ellipse, being elongated in the third direction, when viewed in the first direction. The first groove portion 10e is arranged at the outer circumferential portion of the partition wall portion 10d. The first groove portion 10e is arranged to extend along the outer circumferential portion of the partition wall portion 10d. The first groove portion 10e is arranged in a surface facing the second side in the first direction at the outer circumferential portion of the partition wall portion 10d, and is arranged to open to the second side in the first direction.

The first flange portion 10h is located outside of the first groove portion 10e when viewed in the first direction. The first flange portion 10h is joined to the outer circumferential portion of the partition wall portion 10d. The first flange portion 10h is in the shape of a plate. The first flange portion 10h is arranged to extend perpendicularly to the first direction. Other features of the first flange portion 10h will be described separately below.

Each nut holding portion 10f is arranged to extend along the one of the pair of first extending portions 9a of the corresponding busbar 9 which is located on the first side in the first direction. The nut holding portion 10f holds the corresponding nut portion 19. The nut portion 19 is inserted toward the second side in the first direction into the nut holding portion 10f. When the nut portion 19 is held by the nut holding portion 10f, the nut portion 19 is restrained from moving in the second direction or the third direction relative to the nut holding portion 10f. The nut portion 19 is arranged opposite to the corresponding through hole 9c. In the present preferred embodiment, the nut portion 19 is arranged on the lower side of the corresponding busbar 9 and opposite to the through hole 9c on the lower side thereof. According to the present preferred embodiment, one of the wiring screw portions 18 is passed through the through hole 9c of each busbar 9, and is screwed into the nut portion 19 held by the corresponding nut holding portion 10f, so that the busbar 9 is connected to the corresponding wiring member 33 of the motor 2. The busbars 9 can be connected to the respective wiring members 33 with a simple structure using the first joining member 10 as a terminal block. In addition, an increase in flexibility in arranging wires in the housing 6 can be achieved.

Each insulating wall portion 10g is arranged to extend from the partition wall portion 10d to the first side in the first direction. The insulating wall portion 10g is in the shape of a plate, extending perpendicularly to the third direction. The insulating wall portion 10g is arranged to extend in the first direction between adjacent ones of the busbars 9. The insulating wall portions 10g, the number of which is more than one (specifically, two), are arranged side by side in the third direction. In the present preferred embodiment, on the first side of the partition wall portion 10d in the first direction, adjacent ones of the busbar fixing portions 10c are joined to each other through one of the insulating wall portions 10g in the third direction. According to the present preferred embodiment, each insulating wall portion 10g provides insulation between adjacent ones of the busbars 9.

The second joining member 14 is made of a resin. The second joining member 14 is made of, for example, a PPS resin containing an elastomer component. The second joining member 14 is defined by a single monolithic member. The second joining member 14 is preferably made of the same material as that of the first joining member 10.

The second joining member 14 is fitted to the housing 6. The second joining member 14 is fitted to the wall portion 6e of the motor housing portion 6a. The second joining member 14 is arranged to be in contact with the housing 6 in the first direction. The second joining member 14 is fixed to the housing 6 through the second screw members 16, which will be described below.

That is, the second joining member 14 is fixed to the housing 6. The second joining member 14 is located between the housing 6 and the inverter case 8 in the first direction, and is arranged at the second opening hole 6c. The second joining member 14 is arranged opposite to the first joining member 10 in the first direction. The busbars 9 are passed through the second joining member 14. The busbars 9 are inserted toward the first side in the first direction into the second joining member 14. An end portion of each busbar 9 on the first side in the first direction is arranged to project to the first side in the first direction from the second joining member 14.

The second joining member 14 is arranged to be smaller in dimension in the second direction than in dimension in the third direction when viewed in the first direction. In other words, the second joining member 14 is arranged to extend in the third direction. According to the present preferred embodiment, the busbars 9 are arranged in the third direction, and accordingly, the second joining member 14 is arranged to be greater in external dimension in the third direction than in external dimension in the second direction. Thus, excessively large external dimensions (especially, an excessively large external dimension in the second direction) of the second joining member 14 can be avoided. This leads to a reduced cost of the material of the second joining member 14, and makes it easier to ensure sufficient strength of the fixing of the second joining member 14 to the housing 6.

The second joining member 14 includes a fitting wall portion 14b, the tubular guide portion 14a, the inner tubular portion 14c, a joining wall portion 14d, a second groove portion 14e, and a second flange portion 14f.

The fitting wall portion 14b is in the shape of a plate. The fitting wall portion 14b is in the shape of a plate, extending perpendicularly to the first direction. The fitting wall portion 14b is annular, and is arranged to extend along an edge of the second opening hole 6c. The fitting wall portion 14b is in the shape of an ellipse, being elongated in the third direction, when viewed in the first direction. The fitting wall portion 14b is in the shape of an ellipse, with a major axis extending in the third direction and a minor axis extending in the second direction, when viewed in the first direction. An entire portion of the fitting wall portion 14b, excluding an inner circumferential portion thereof, is arranged opposite to an entire hole periphery of the second opening hole 6c in the wall portion 6e on the second side thereof in the first direction. In the present preferred embodiment, the “hole periphery of the second opening hole 6c” refers to an annular portion of the wall portion 6e which is arranged adjacent to the edge of the second opening hole 6c and which extends along the edge of the second opening hole 6c.

The tubular guide portion 14a is tubular, and is arranged to extend from the fitting wall portion 14b to the first side in the first direction. The tubular guide portion 14a is arranged to extend from the inner circumferential portion of the fitting wall portion 14b to the first side in the first direction. The tubular guide portion 14a is in the shape of an ellipse, being elongated in the third direction, when viewed in the first direction. The tubular guide portion 14a is in the shape of an ellipse, with a major axis extending in the third direction and a minor axis extending in the second direction, when viewed in the first direction. The tubular guide portion 14a is inserted into the second opening hole 6c. In the present preferred embodiment, the tubular guide portion 14a is fitted into the second opening hole 6c. According to the present preferred embodiment, the second joining member 14 and the housing 6 are positioned and assembled through the tubular guide portion 14a being fitted into the second opening hole 6c. Thus, the second joining member 14 and the first joining member 10 can be fitted together with stable alignment, facilitating assembly. The busbars 9 are arranged apart from the tubular guide portion 14a inside of the tubular guide portion 14a when viewed in the first direction. The tubular guide portion 14a provides insulation between a wall of the second opening hole 6c and the busbars 9.

Referring to FIG. 3, the tubular guide portion 14a includes a tapered receiving surface 14h. The tapered receiving surface 14h is arranged at an opening portion located at an end portion of the inner circumferential surface of the tubular guide portion 14a on the second side in the first direction. The tapered receiving surface 14h is a slanting surface arranged to slant outward in the second opening hole 6c while extending to the second side in the first direction when viewed in the first direction. That is, referring to FIG. 3, the tapered receiving surface 14h is arranged to slant toward an outer circumferential portion of the fitting wall portion 14b while extending to the second side in the first direction in a section taken along the first direction. According to the present preferred embodiment, it is easy to insert the tubular insertion portion 10b inside of the tubular guide portion 14a because of the tapered receiving surface 14h arranged at an opening portion of the tubular guide portion 14a on the second side in the first direction. Accordingly, it is easy to fit the first joining member 10, which is attached to the inverter case 8, and the second joining member 14, which is attached to the housing 6, together.

The inner tubular portion 14c is arranged inside of the tubular guide portion 14a. The inner tubular portion 14c is arranged inwardly apart from the tubular guide portion 14a when viewed in the first direction. The shape of the inner tubular portion 14c and the shape of the tubular guide portion 14a are substantially similar to each other when viewed in the first direction. The busbars 9 are arranged apart from the inner tubular portion 14c inside of the inner tubular portion 14c when viewed in the first direction. The inner tubular portion 14c provides insulation between the wall of the second opening hole 6c and the busbars 9.

The inner tubular portion 14c includes a tapered guide surface 14g. The tapered guide surface 14g is arranged at an end portion of an outer circumferential surface of the inner tubular portion 14c on the second side in the first direction. The tapered guide surface 14g is a slanting surface arranged to slant inward in the second opening hole 6c while extending to the second side in the first direction when viewed in the first direction. That is, the tapered guide surface 14g is arranged to slant toward an inner circumferential surface of the inner tubular portion 14c while extending to the second side in the first direction in a section taken along the first direction. According to the present preferred embodiment, it is easy to fit the tubular insertion portion 10b to an outside of the inner tubular portion 14c because of the tapered guide surface 14g arranged at an end portion of the inner tubular portion 14c on the second side in the first direction.

An end portion of the inner tubular portion 14c on the first side in the first direction and an end portion of the tubular guide portion 14a on the first side in the first direction are joined to each other through the joining wall portion 14d. The joining wall portion 14d is in the shape of a plate. The joining wall portion 14d is in the shape of a plate, extending perpendicularly to the first direction. The joining wall portion 14d is annular, and is arranged to extend along the edge of the second opening hole 6c. According to the present preferred embodiment, the oil O or the like in the housing 6 does not easily reach a gap between the insertion portion 10b and the tubular guide portion 14a due to the inner tubular portion 14c arranged inside of the insertion portion 10b and the joining wall portion 14d arranged on the first side of the insertion portion 10b in the first direction. Accordingly, a reduction in the likelihood that the oil O or the like in the housing 6 will leak out of the housing 6 through the gap between the insertion portion 10b and the tubular guide portion 14a can be achieved. In addition, a reduction in the likelihood of a deterioration of the third seal portion 13, which will be described below, can be achieved, which leads to an extended life of the third seal portion 13.

The second groove portion 14e is defined in a surface of the second joining member 14 which is opposite to the housing 6. The second groove portion 14e is annular, surrounding the second opening hole 6c, when viewed in the first direction. The second groove portion 14e is in the shape of an ellipse, being elongated in the third direction, when viewed in the first direction. The second groove portion 14e is arranged in the fitting wall portion 14b. The second groove portion 14e is annular, and is arranged to extend along the fitting wall portion 14b. The second groove portion 14e is arranged in a surface of the fitting wall portion 14b which faces the first side in the first direction, and is arranged to open to the first side in the first direction.

The second flange portion 14f is located outside of the second groove portion 14e when viewed in the first direction. The second flange portion 14f is joined to the outer circumferential portion of the fitting wall portion 14b. The second flange portion 14f is in the shape of a plate. The second flange portion 14f is arranged to extend perpendicularly to the first direction. Other features of the second flange portion 14f will be described separately below.

The first seal portion 11 is arranged between the inverter case 8 and the first joining member 10 in the first direction, and is arranged to be in contact with the inverter case 8 and the first joining member 10. The first seal portion 11 is arranged between a surface of the first joining member 10 which faces the second side in the first direction and a surface of the inverter case 8 which is opposite to this surface and which faces the first side in the first direction. The first seal portion 11 is capable of elastic deformation. According to the present preferred embodiment, sealing between the inverter case 8 and the first joining member 10 is achieved by the first seal portion 11. Because the first seal portion 11 is held between the inverter case 8 and the first joining member 10 in the first direction, a pressing force applied by the first screw members 15 in the first direction acts evenly over the whole first seal portion 11. Thus, a sealing function of the first seal portion 11 can be stably fulfilled. A reduction in the likelihood that the first seal portion 11 will be, for example, twisted or damaged during assembly can be achieved. The first seal portion 11 reduces the likelihood that a liquid, such as, for example, water or an oil, a foreign body, or the like will enter into an interior of the inverter case 8. The first seal portion 11 ensures sufficient sealing of the first opening hole 8c.

The first seal portion 11 is annular, surrounding the first opening hole 8c, when viewed in the first direction. The first seal portion 11 is in the shape of an ellipse, being elongated in the third direction, when viewed in the first direction. In the present preferred embodiment, the first seal portion 11 is an O ring or the like as a member separate from the first joining member 10. According to the present preferred embodiment, an entry of a liquid, such as, for example, water or an oil, a foreign body, or the like into the interior of the inverter case 8 through the first opening hole 8c can be more securely prevented by the first seal portion 11. Sealing performance of the first seal portion 11 is maintained at a satisfactory level due to the first screw members 15, which will be described below.

The first seal portion 11 is arranged in the first groove portion 10e. According to the present preferred embodiment, it is easy to fit the first seal portion 11 to the first joining member 10, and a displacement of the first seal portion 11 during or after the assembly of the motor unit 1 does not easily occur. The first groove portion 10e ensures stable sealing performance of the first seal portion 11.

The second seal portion 12 is arranged between the housing 6 and the second joining member 14 in the first direction, and is arranged to be in contact with the housing 6 and the second joining member 14. The second seal portion 12 is arranged between a surface of the housing 6 which faces the second side in the first direction and a surface of the second joining member 14 which is opposite to this surface and which faces the first side in the first direction. The second seal portion 12 is capable of elastic deformation. According to the present preferred embodiment, sealing between the housing 6 and the second joining member 14 is achieved by the second seal portion 12. Because the second seal portion 12 is held between the housing 6 and the second joining member 14 in the first direction, a pressing force applied by the second screw members 16 in the first direction acts evenly over the whole second seal portion 12. Thus, a sealing function of the second seal portion 12 can be stably fulfilled. A reduction in the likelihood that the second seal portion 12 will be, for example, twisted or damaged during assembly can be achieved. The second seal portion 12 reduces the likelihood that a liquid, such as, for example, water, a foreign body, or the like will enter into the interior of the housing 6, and the likelihood that the oil O or the like will leak out of the housing 6 from the interior of the housing 6. The second seal portion 12 ensures sufficient sealing of the second opening hole 6c.

The second seal portion 12 is annular, surrounding the second opening hole 6c, when viewed in the first direction. The second seal portion 12 is in the shape of an ellipse, being elongated in the third direction, when viewed in the first direction. In the present preferred embodiment, the second seal portion 12 is an O ring or the like as a member separate from the second joining member 14. According to the present preferred embodiment, an entry of a liquid, such as, for example, water, a foreign body, or the like into the interior of the housing 6 through the second opening hole 6c, and a leakage of the oil O or the like out of the housing 6 from the interior of the housing 6, can be more securely prevented by the second seal portion 12. Sealing performance of the second seal portion 12 is maintained at a satisfactory level due to the second screw members 16, which will be described below.

The second seal portion 12 is arranged in the second groove portion 14e. According to the present preferred embodiment, it is easy to fit the second seal portion 12 to the second joining member 14, and a displacement of the second seal portion 12 during or after the assembly of the motor unit 1 does not easily occur. The second groove portion 14e ensures stable sealing performance of the second seal portion 12. In the example of the present preferred embodiment, the second seal portion 12 and the first seal portion 11 are arranged to overlap with each other when viewed in the first direction. That is, the second groove portion 14e and the first groove portion 10e are arranged to overlap with each other when viewed in the first direction.

The third seal portion 13 is arranged to seal a gap between the first joining member 10 and the second joining member 14. The third seal portion 13 is arranged between the inner circumferential surface of the tubular guide portion 14a and the outer circumferential surface of the tubular insertion portion 10b, which is opposite to the inner circumferential surface of the tubular guide portion 14a. The third seal portion 13 is arranged to be in contact with the inner circumferential surface of the tubular guide portion 14a and the outer circumferential surface of the insertion portion 10b. That is, the third seal portion 13 seals a gap between the inner circumferential surface of the tubular guide portion 14a and the outer circumferential surface of the insertion portion 10b. The third seal portion 13 is capable of elastic deformation. According to the present preferred embodiment, sealing between the first joining member 10 and the second joining member 14 is achieved by the third seal portion 13. In more detail, during the assembly of the motor unit 1, the third seal portion 13 is brought into contact with the outer circumferential surface of the tubular insertion portion 10b and the inner circumferential surface of the tubular guide portion 14a as a result of the insertion portion 10b of the first joining member 10 being inserted inside of the tubular guide portion 14a of the second joining member 14, so that sealing between the above outer and inner circumferential surfaces is achieved. That is, the third seal portion 13 seals the gap between the insertion portion 10b and the tubular guide portion 14a in radial directions with respect to a central axis of a portion of one of the busbars 9 which extends in the first direction. The third seal portion 13 reduces the likelihood that a liquid, such as, for example, water, a foreign body, or the like will enter into the interior of the housing 6, and the likelihood that the oil O or the like will leak out of the housing 6 from the interior of the housing 6. Sufficient sealing between the first joining member 10 and the second joining member 14 is ensured by the third seal portion 13, so that sufficient sealing of the second opening hole 6c is ensured.

The third seal portion 13 is annular, and is arranged to extend along the outer circumferential surface of the tubular insertion portion 10b when viewed in the first direction. The third seal portion 13 is in the shape of an ellipse, extending along the outer circumferential surface of the tubular insertion portion 10b, when viewed in the first direction. In the present preferred embodiment, the third seal portion 13 is an O ring or the like as a member separate from the insertion portion 10b. According to the present preferred embodiment, an entry of a liquid, such as, for example, water, a foreign body, or the like into the interior of the housing 6 through the gap between the insertion portion 10b of the first joining member 10 and the tubular guide portion 14a of the second joining member 14 and the second opening hole 6c, and a leakage of the oil O or the like out of the housing 6 from the interior of the housing 6, can be more securely prevented by the third seal portion 13.

The third seal portion 13 is arranged in the third groove portion 10k. According to the present preferred embodiment, it is easy to fit the third seal portion 13 to the insertion portion 10b, and a displacement of the third seal portion 13 during or after the assembly of the motor unit 1 does not easily occur. The third groove portion 10k ensures stable sealing performance of the third seal portion 13.

In the present preferred embodiment, each of the first joining member 10 and the second joining member 14 is made of a resin, and therefore, each of the first joining member 10 and the second joining member 14 can be shaped with increased flexibility, making it easier to fit the first joining member 10 and the second joining member 14 together. Specifically, it is made possible to define the outer tapered surface 10i at the end portion of the outer circumferential surface of the tubular insertion portion 10b on the first side in the first direction as in the present preferred embodiment to make it easier to insert the tubular insertion portion 10b inside of the tubular guide portion 14a. In addition, it is made possible to define the tapered receiving surface 14h at an opening portion of the inner circumferential surface of the tubular guide portion 14a on the second side in the first direction to make it easier to insert the insertion portion 10b inside of the tubular guide portion 14a. Moreover, a similar advantageous effect can be achieved by each of the inner tapered surface 10j and the tapered guide surface 14g. This facilitates alignment of the first joining member 10 and the second joining member 14 (particularly, positioning thereof in directions perpendicular to the first direction), making it easier to fit the first joining member 10 and the second joining member 14 together.

In addition, each of the first joining member 10 and the second joining member 14 being made of a resin contributes to preventing damage or the like of the third seal portion 13. That is, it is made easier to eliminate a hard edge or the like on which the third seal portion 13 may easily get caught from each of the outer circumferential surface of the tubular insertion portion 10b and the inner circumferential surface of the tubular guide portion 14a, which contributes to preventing a twist, damage, or the like of the third seal portion 13. Thus, a sealing function of the third seal portion 13 can be stably fulfilled.

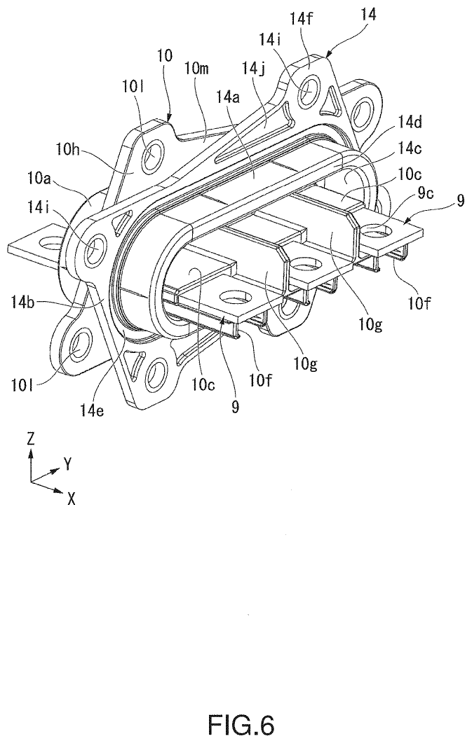

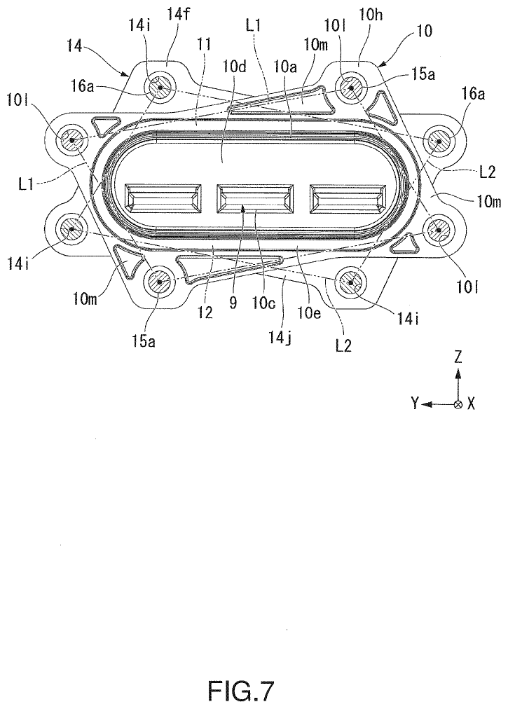

The first flange portion 10h is located outside of the first seal portion 11 when viewed in the first direction. Referring to FIGS. 6 and 7, the first flange portion 10h includes first screw hole portions 101 and first hold-down portions 10m. Each first screw hole portion 10l is arranged to pass through the first flange portion 10h in the first direction, and the first screw hole portions 101 are arranged apart from one another along the edge of the first opening hole 8c at the hole periphery of the first opening hole 8c. One of the first screw members 15 is passed through each first screw hole portion 10l. A central axis of the first screw hole portion 10l and a screw axis of the corresponding first screw member 15 are arranged to substantially coincide with each other. A tubular member made of a metal may be fitted to a wall of each first screw hole portion 10l.

Each first hold-down portion 10m is in the shape of a plate. The first hold-down portion 10m is arranged to extend perpendicularly to the first direction. The first hold-down portion 10m is located outside of the first seal portion 11 between a pair of adjacent ones of the first screw hole portions 101 along the hole periphery of the first opening hole 8c when viewed in the first direction. According to the present preferred embodiment, the pressing force applied by the first screw members 15 in the first direction can be efficiently transferred to the first seal portion 11 through the first hold-down portions 10m.

A first imaginary line segment L1 that joins a pair of first screw members 15 (i.e., screw axes of first screw members 15) adjacent to each other along the hole periphery of the first opening hole 8c to each other is arranged to overlap at least in part with the first seal portion 11 when viewed in the first direction. According to the present preferred embodiment, the pressing force applied by the first screw members 15 in the first direction is allowed to stably act on the first seal portion 11. Thus, the sealing function of the first seal portion 11 can be more stably fulfilled.

The second flange portion 14f is located outside of the second seal portion 12 when viewed in the first direction. The second flange portion 14f includes second screw hole portions 14i and second hold-down portions 14j. Each second screw hole portion 14i is arranged to pass through the second flange portion 14f in the first direction, and the second screw hole portions 14i are arranged apart from one another along the edge of the second opening hole 6c along the hole periphery of the second opening hole 6c. One of the second screw members 16 is passed through each second screw hole portion 14i. A central axis of the second screw hole portion 14i and a screw axis of the corresponding second screw member 16 are arranged to substantially coincide with each other. A tubular member made of a metal may be fitted to a wall of each second screw hole portion 14i.

Each second hold-down portion 14j is in the shape of a plate. The second hold-down portion 14j is arranged to extend perpendicularly to the first direction. The second hold-down portion 14j is located outside of the second seal portion 12 between a pair of adjacent ones of the second screw hole portions 14i along the hole periphery of the second opening hole 6c when viewed in the first direction. According to the present preferred embodiment, the pressing force applied by the second screw members 16 in the first direction can be efficiently transferred to the second seal portion 12 through the second hold-down portions 14j.

A second imaginary line segment L2 that joins a pair of second screw members 16 (i.e., screw axes of second screw members 16) adjacent to each other along the hole periphery of the second opening hole 6c to each other is arranged to overlap at least in part with the second seal portion 12 when viewed in the first direction. According to the present preferred embodiment, the pressing force applied by the second screw members 16 in the first direction is allowed to stably act on the second seal portion 12. Thus, the sealing function of the second seal portion 12 can be more stably fulfilled.

Each first screw member 15 is arranged to extend in the first direction. The first screw member 15 includes a screw shank portion 15a having a male screw portion in an outer circumference thereof, and a screw head portion 15b having an outside diameter greater than that of the screw shank portion 15a. The first screw members 15 are used to fix the first joining member 10 to the inverter case 8. The number of first screw members 15 is more than one. The first screw members 15 are arranged apart from one another along the edge of the first opening hole 8c at the hole periphery of the first opening hole 8c.

Each second screw member 16 is arranged to extend in the first direction. The second screw member 16 includes a screw shank portion 16a having a male screw portion in an outer circumference thereof, and a screw head portion 16b having an outside diameter greater than that of the screw shank portion 16a. The second screw members 16 are used to fix the second joining member 14 to the housing 6. The number of second screw members 16 is more than one. The second screw members 16 are arranged apart from one another along the edge of the second opening hole 6c at the hole periphery of the second opening hole 6c.

According to the present preferred embodiment, the first joining member 10 is stably fixed to the inverter case 8 through the first screw members 15. The second joining member 14 is stably fixed to the housing 6 through the second screw members 16. Fitting together of the housing 6 and the inverter case 8 can be easily accomplished by fitting the first joining member 10 fixed to the inverter case 8 and the second joining member 14 fixed to the housing 6 together.

The first screw members 15 and the second screw members 16 are alternately arranged so as not to overlap with one another when viewed in the first direction.

According to the present preferred embodiment, a stable condition of fixing (i.e., a sufficient strength of fixing) of the first joining member 10 to the inverter case 8 is achieved without the first screw members 15 being spaced too widely apart from one another. A stable condition of fixing of the second joining member 14 to the housing 6 is achieved without the second screw members 16 being spaced too widely apart from one another. It is possible to minimize the distance between the inverter case 8 and the housing 6 in the first direction since the first screw members 15 and the second screw members 16 do not overlap with one another when viewed in the first direction. Specifically, the distance between the inverter case 8 and the housing 6 in the first direction only needs to be long enough for the screw head portion 15b or 16b of the first screw member 15 or the second screw member 16 to be accommodated in a space therebetween. Thus, a reduced size of the motor unit 1 can be achieved.

The first screw members 15 and the second screw members 16 are arranged symmetrically with respect to a symmetry axis perpendicular to the first direction when viewed in the first direction. Specifically, as illustrated in FIG. 7, the plurality (specifically, four) of first screw members 15 and the plurality (specifically, four) of second screw members 16 are arranged symmetrically with respect to a symmetry axis parallel to the z-axis and passing through a center of the first seal portion 11 (or the second seal portion 12) when viewed in the first direction. In addition, the plurality of first screw members 15 and the plurality of second screw members 16 are arranged symmetrically with respect to a symmetry axis parallel to the y-axis and passing through the center of the first seal portion 11. The present preferred embodiment allows the first flange portion 10h of the first joining member 10 and the second flange portion 14f of the second joining member 14 to have line symmetry when viewed in the first direction. This facilitates assembly and manufacture of each member.

In the present preferred embodiment, the number of first screw members 15 is four. Line segments (i.e., the first imaginary line segments L1) joining the four first screw members 15 when viewed in the first direction form a parallelogram having each first screw member 15 as a vertex. The number of second screw members 16 is four. Line segments (i.e., the second imaginary line segments L2) joining the four second screw members 16 when viewed in the first direction form a parallelogram having each second screw member 16 as a vertex. The present preferred embodiment allows each of the first flange portion 10h and the second flange portion 14f to have relatively small external dimensions. The sealing function of the first seal portion 11 can be stably fulfilled with each first screw member 15 being arranged closer to the first seal portion 11. The sealing function of the second seal portion 12 can be stably fulfilled with each second screw member 16 being arranged closer to the second seal portion 12. The strength of the fixing achieved by the first screw members 15 and the second screw members 16 can thus be made more stable.

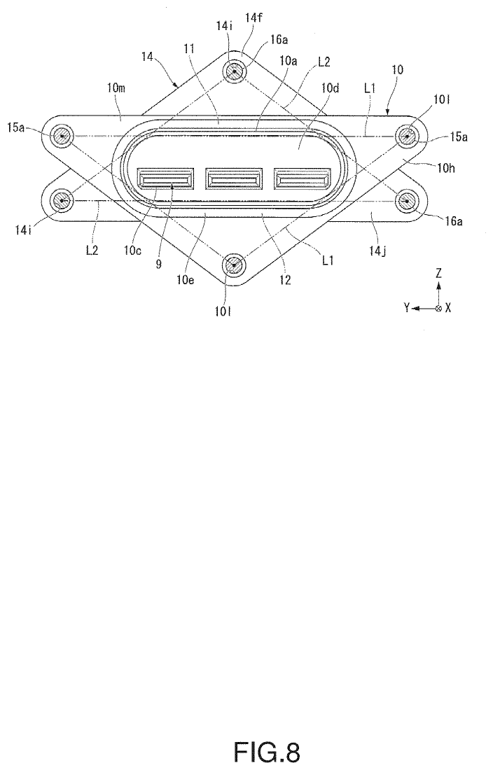

FIG. 8 illustrates a modification of the present preferred embodiment. In this modification, the number of first screw members 15 and the number of second screw members 16 are both three. Line segments (i.e., first imaginary line segments L1) joining the three first screw members 15 when viewed in the first direction form an isosceles triangle having each first screw member 15 as a vertex, and line segments (i.e., second imaginary line segments L2) joining the three second screw members 16 when viewed in the first direction form an isosceles triangle having each second screw member 16 as a vertex.

In this case, reductions in the number of first screw members 15 and the number of second screw members 16 are achieved, resulting in increased ease of assembly. In the case where the inverter case 8 and the motor housing portion 6a are arranged adjacent to each other in a radial direction with respect to the motor axis J2 as in the present preferred embodiment, it is difficult to ensure sufficient sealing of each of the second opening hole 6c and the first opening hole 8c while facilitating assembly of a supporting structure for the busbars 9 extending over the inverter case 8 and the motor housing portion 6a. According to the present preferred embodiment, it is easy to assemble the supporting structure for the busbars 9, and sufficient sealing of each of the second opening hole 6c and the first opening hole 8c is ensured.

In the present preferred embodiment, since the inverter case 8 and the motor housing portion 6a are arranged adjacent to each other in the horizontal direction, a reduction in the external dimension of the motor unit 1 in the vertical direction (i.e., the direction of gravity) can be achieved. This will make it easier to install the motor unit 1 in a limited space in, for example, the vehicle.

Note that the present invention is not limited to the above-described preferred embodiments, and that various modifications, etc., can be made without departing from the scope and spirit of the present invention, as described below, for example.

In the above-described preferred embodiment, the second joining member 14 includes the inner tubular portion 14c, but this is not essential to the present invention. In a configuration where the second opening hole 6c is covered with the oil O, for example, it is preferable that the second joining member 14 does not include the inner tubular portion 14c.

The first seal portion 11 may not be the O ring. The first seal portion 11 may alternatively be in a liquid or gel state. The first seal portion 11 may alternatively be made of a silicone resin. The first seal portion 11 may alternatively be incapable of elastic deformation. The first seal portion 11 and the first joining member 10 may alternatively be portions of a single monolithic member molded by a double injection molding process.

The second seal portion 12 may not be the O ring. The second seal portion 12 may alternatively be in a liquid or gel state. The second seal portion 12 may alternatively be made of a silicone resin. The second seal portion 12 may alternatively be incapable of elastic deformation. The second seal portion 12 and the second joining member 14 may alternatively be portions of a single monolithic member produced by a double injection molding process.

The third seal portion 13 may not be the O ring. The third seal portion 13 may alternatively be in a liquid or gel state. The third seal portion 13 may alternatively be made of a silicone resin. The third seal portion 13 may alternatively be incapable of elastic deformation. The third seal portion 13 and the first joining member 10 may alternatively be portions of a single monolithic member produced by a double injection molding process.

It may be sufficient if the pressure regulating passage 17b is arranged in the cover portion 17, and the shape of the pressure regulating passage 17b is not limited to the example according to the present preferred embodiment. For example, the pressure regulating passage may alternatively include first and second passages arranged to substantially assume the shape of the letter “Y” or the letter “L”. In addition, a breather valve may be provided in place of the pipe portion 17d.

Without departing from the scope and spirit of the present invention, features or components of the above-described preferred embodiment and the above-described modifications thereof and features or components mentioned above as alternatives may be combined in various manners, and an addition, elimination, and substitution of a feature(s) or component(s), and other modifications can be made. In addition, the present invention is not limited by the above-described preferred embodiment and the modifications thereof, but is limited only by the appended claims.

1. A motor unit comprising:
a motor including a rotor arranged to rotate about a motor axis, and a stator arranged opposite to the rotor;
a housing arranged to house the motor;
an inverter electrically connected to the motor;
a busbar arranged to connect the motor and the inverter to each other; and
a cover portion; wherein
the housing includes a motor housing portion arranged to house the motor, a top wall portion arranged to cover an upper side of the motor housing portion, and a work-use hole portion arranged to pass through the top wall portion;
the cover portion is arranged to close an upper opening of the work-use hole portion; and
the cover portion includes a pressure regulating passage arranged to regulate a pressure in an interior of the housing.

2. The motor unit according to claim 1, wherein
the cover portion includes a body portion and a pipe portion arranged to project from the body portion; and
the pressure regulating passage is defined in the body portion and the pipe portion.

3. The motor unit according to claim 2, wherein
the body portion includes a flange portion and a projecting portion arranged to project from the flange portion toward the busbar;
the pressure regulating passage includes a first passage, a second passage, and a third passage;
the first passage is defined in the projecting portion;
the second passage is defined in the projecting portion and the flange portion; and
the third passage is defined in the pipe portion.

4. The motor unit according to claim 3, wherein
the flange portion is in a shape of a plate, and is substantially in a shape of a rectangle in a plan view, with a minor axis extending in a first direction and a major axis extending in a third direction; and
the first passage is arranged to pass through the projecting portion with both end portions of the first passage opening in the third direction.

5. The motor unit according to claim 3, wherein, in the projecting portion, the first passage is arranged to extend in a direction perpendicular to a direction in which the work-use hole portion extends.

6. The motor unit according to claim 3, wherein
the first passage and the second passage are arranged to substantially assume a shape of letter T; and
one end of the second passage is joined to the first passage, while another end of the second passage is joined to the third passage.

7. The motor unit according to claim 3, wherein the projecting portion is arranged in the work-use hole portion.

8. The motor unit according to claim 3, wherein
the flange portion includes a flange hole portion; and
the cover portion is fixed to the housing with a screw inserted through the flange hole portion.

9. The motor unit according to claim 1, wherein
in the housing, the work-use hole portion is arranged to open toward the busbar;
the cover portion is located on one end side of the work-use hole portion; and
the busbar is located on another end side of the work-use hole portion.

10. The motor unit according to claim 1, further comprising an electrical connection chamber being a space surrounded by an inner peripheral surface of the housing and an outer peripheral surface of the stator, wherein the electrical connection chamber is arranged to be in communication with a space outside of the housing through the work-use hole portion.

11. The motor unit according to claim 3, wherein
in the housing, the work-use hole portion is arranged to open toward the busbar;
the cover portion is located on one end side of the work-use hole portion; and
the busbar is located on another end side of the work-use hole portion.

12. The motor unit according to claim 3, further comprising an electrical connection chamber being a space surrounded by an inner peripheral surface of the housing and an outer peripheral surface of the stator, wherein the electrical connection chamber is arranged to be in communication with a space outside of the housing through the work-use hole portion.
